(19) United States
(12) Patent Application Publication
(10) Pub. No.: US 2011/0019616 A1
(43) Pub. Date: Jan. 27, 2011

(54) RADIO GATEWAY NETWORK

(75) Inventors: Chin Kang Lee, Singapore (SG); Yew Kwee Lew, Singapore (SG)

Correspondence Address: SUGHRUE MION, PLLC, 2100 PENNSYLVANIA AVENUE, N.W., SUITE 800, WASHINGTON, DC, 20037, US

(73) Assignee: ST ELECTRONICS (INFO-COMM SYSTEMS) PTE LTD., SINGAPORE (SG)

(21) Appl. No.: 12/810,651

(22) PCT Filed: Dec. 28, 2007
(86) PCT No.: PCT/SG07/00443

§ 371 Date: Oct. 4, 2010

(51) Int. Cl. H04W 4/00; H04L 12/66

(52) U.S. Cl. 370/328; 370/352

(57) ABSTRACT

A radio gateway network and method is disclosed in which a first master radio gateway is provided and at least one second slave gateway is provided. The first gateway establishes at least one radio net comprised of radios which communicate with at least one of the gateways. The radio net enables communication from a user terminal to radios in the radio net wherein the number of radios in the radio net is greater than the number of ports of each respective gateway.

### FIELD OF THE INVENTION

This invention relates to a radio gateway network and to a radio gateway method for providing radio voice communications using voice-over-internet protocol to allow a user radio to communicate with a plurality of receiving radios associated with different radio gateways.

### BACKGROUND OF THE INVENTION

One of the applications of a radio gateway network is to address the needs of radio inoperability. Conventional systems do not readily enable different makes of radio, types, and operating frequencies to interoperate if they support 4-wires audio interface (audio transmit pair and audio receive pair) and a PTT control for audio transmission. It is not necessary for the radio to be used with the network to provide Carrier-Operate-Relay signals to indicate the presence of a carrier signal. The radio gateway has a built in Voice Modulation Recognition (VMR) to detect for the presence of speech.

However it is recommended to use a Carrier-Operate-Relay signal from the radio instead of the VMR to detect for reception of signals. A digital signal processor is implemented to run the algorithm for speech detection and the algorithm will require at least 250 ms to detect speech reliably especially in the presence of noise. This will incur a voice latency of at least 200 ms in addition to the delay of the VoIP transmission.

Radio patching is an important feature of a gateway to support radio interoperability. Audio from a receiving radio will be retransmitted to another via the gateway. The carrier operated relay signal from the receiving radio serves as an indicator to trigger (by pressing the press to talk) of the other radio for retransmission. When the receiver radio did not supply the signal, VMR has to be used for detection of speech.

In certain applications, the radios may be deployed far apart. A system integrator will need to use 2 or more gateways to interface with the respective radio. The gateways will not be able to perform the radio patching function across different gateways. Under such a deployment scenario, a media server may be required to relay the audio from a receiving gateway to a transmitting gateway. A gateway may be designed with 8 radio interface ports. When the deployment requires 9 or more radios an additional gateway is required to increase the number of radio interface ports. Radio on one gateway cannot be patched to the other gateway. A media server is still required to perform the patching function even though the radios may be located nearby. The addition of the media server will incur an additional one hop delay (100 ms) as compared to normal radio access.

### SUMMARY OF THE INVENTION

The object of the invention is to overcome the above problem and allow radio communication between radios having more deployments than interface ports of a single gateway whilst at the same time improving the speech delay.

The invention provides a radio gateway network for radio voice communications using voice-over-internet protocol, the network comprising:

a first radio gateway having at least one radio interface port;
at least one second radio gateway having at least one radio interface port;
the first radio gateway being configured to act as a master gateway and for polling the at least one second gateway for determining the available radio interface ports to establish at least one radio net comprised of radios which commute with at least two of the gateways of the group comprising the first gateway and at least one second gateway;
a communication link between the first gateway and the at least one second gateway; and
wherein the first gateway receives a request for connection to the radios associated with the radio interfaces of the first gateway and at least one second gateway and grants or rejects access so that upon grant of access an end terminal transmits a voice signal to one of the gateways via the communication link for transmission to individual radios connected to the radio interface ports and/or the radios in the at least one radio net.

Thus, if voice transmission is required to a number of radios which are greater in number than the interface ports of one of the gateways the establishment of the radio net transmission to the radios in the radio net enables a greater number of radios to simultaneously receive the voice signal. Therefore communication from an end terminal to a number of radios greater than the number of interface ports associated with a gateway is possible and reduced speech delay is also achieved.

In one embodiment the first gateway establishes a database of unique dialing numbers for each radio interface port and each radio net and is for transmitting the database to each of the at least One second gateway.

In one embodiment at least two of the gateways comprise the first gateway and at least one second gateway.

In one embodiment the first gateway is for transmitting a signal to the at least one second gateway and for receiving a response from the at least one second gateway to provide an indication of the readiness of the network.

In one embodiment the first gateway is for removing the unique dialing number of a non-responding one of the at least one second gateway and for updating the database after removal of that dialing number and transmitting the updated database to the remaining gateways in the gateways comprising the at least one second gateway.

In one embodiment the first gateway is for receiving a signal back from the at least one second gateway and in the event that no signal is received from all of the gateways comprising the at least one second gateway, the first gateway is for shutting down the radio net and reverting back to operation in a stand alone mode in which the first gateway communicates only with radios associated with its radio interfaces.

In one embodiment the first gateway is for determining receipt of the signal from a gateway of the at least one second gateways following removal of the unique number of that gateway and returning that gateway to the network by redetermining the available radio net and updating the database, and transmitting the updated database to all of the gateways comprised of the at least one second gateway.

In one embodiment one of the first gateway and at least one second gateway receives a request from the end terminal to initiate a voice-over-internet protocol to communicate with radios associated with the gateways; and when the first gateway receives the request the first gateway either grants or rejects the request and transmits that decision back to the end terminal.

In the event of a request being received by the at least one second gateway, the at least one second gateway transmits a signal back to the end terminal rejecting the request if the radio net is busy, or otherwise transmits the request to the first gateway so the first gateway can either grant or reject the request and transmit a decision back to the at least one second gateway for retransmission to the user end terminal.

In one embodiment the first gateway grants or rejects the request based on any one of a first come first serve basis, and a higher priority first policy.

In the higher priority first policy a number of the user end terminals may be designated as more important than others and communications destined for the radios will be allowed over and above communications to other user end terminals.

The invention provides a radio gateway method to provide for radio voice communications using voice-over-internet protocol, the method comprising:
providing a first radio gateway having at least one radio interface port;
providing at least one second radio gateway having at least one radio interface port;

configuring the first radio gateway to act as a master gateway and for polling the at least one second gateway for determining the available radio interface ports to establish at least one radio net comprised of radios which commute with at least two of the gateways of the group comprising the first gateway and at least one second gateway;
establishing a communication link between the first gateway and the at least one second gateway; and
wherein the first gateway receives a request for connection to the radios associated with the radio interfaces of the first gateway and at least one second gateway and grants or rejects access so that upon grant of access an end terminal transmits a voice signal to one of the gateways via the communication link for transmission to individual radios connected to the radio interface ports and/or the radios in the at least one radio net.

In one embodiment the first gateway establishes a database of unique dialing numbers for each radio interface port and each radio net and is for transmitting the database to each of the at least one second gateway.

In one embodiment at least two of the gateways comprise the first gateway and at least one second gateway.

In one embodiment the first gateway transmits a signal to the at least one second gateway and receives a response from the at least one second gateway to provide an indication of the readiness of the network.

In one embodiment the first gateway removes the unique dialing number of a non-responding one of the at least one second gateway and updates the database after removal of that dialing number and transmits the updated gateway to the remaining gateways in the gateways comprising the at least one second gateway.

In one embodiment the first gateway receives a signal back from the at least one second gateway and in the event that no signal is received from all of the gateways comprising the at least one second gateway, the first gateway shuts down the radio net and reverts back to operation in a stand alone mode in which the first gateway communicates only with radios associated with its radio interfaces.

In one embodiment the first gateway determines receipt of the signal from a gateway of the at least one second gateways following removal of the unique number of that gateway and returns that gateway to the radio net by redetermining the available radio net and updating the database, and transmitting the updated database to all of the gateways comprised of the at least one second gateway.

In one embodiment one of the first gateway and at least one second gateway receives a request from an end terminal to initiate a voice-over-internet protocol to communicate with radios associated with the gateways; and when the first gateway receives the request the first gateway either grants or rejects the request and transmits that decision back to the end user terminal;

In the event that a request being received by the at least one second gateway, the at least one second gateway transmits a signal back to the end terminal rejecting the request if the radio net is busy, or otherwise transmits the request to the first gateway so the first gateway can either grant or reject the request and transmit a decision back to the at least one second gateway for retransmission to the user end terminal.

In one embodiment the first gateway grants or rejects the request based on any one of a first come first serve basis, and a higher priority first policy.

### BRIEF DESCRIPTION OF THE DRAWINGS

Embodiments of the invention will be described, by way of example, with reference to the accompanying drawings in which:

FIG. 1 is a view of a radio patching system according to the prior art;

FIG. 2 is a view of a network according to one embodiment of the invention;

FIG. 3 is a view of the network of FIG. 2 showing press to talk accessing of the network;

FIG. 4 is a diagram similar to FIG. 3 showing the data flow path for audio transmissions;

FIGS. 5a, 5b and 5c are a flowchart relating to one embodiment of the invention; and

FIG. 6 is a second flowchart relating to one embodiment of the invention.

### DETAILED DESCRIPTION OF THE EMBODIMENTS

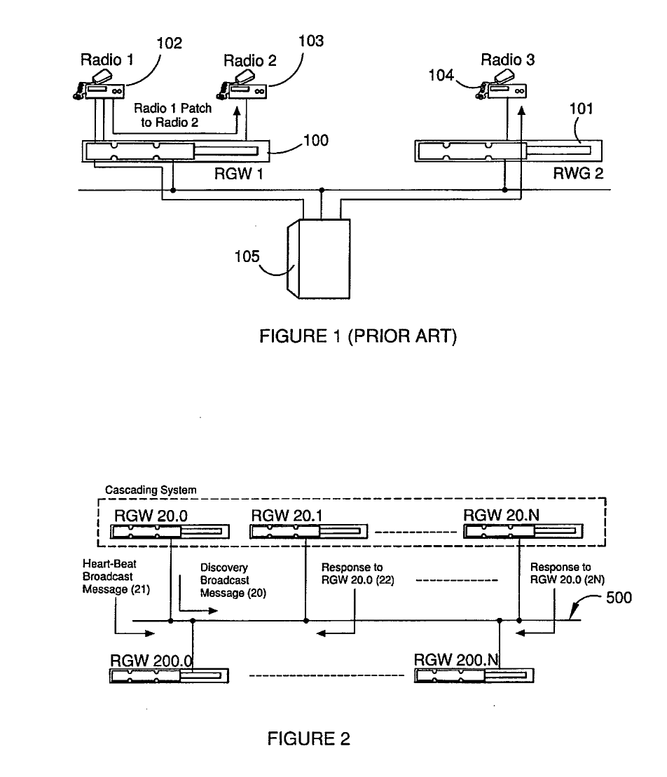

With reference to FIG. 1 a prior art network is shown which has a radio gateway 100 and a radio gateway 101. Radio gateway 100 has a number of interface ports for a plurality of radios such as radios 102 and 103. Similarly the gateway 101 has a number of interface ports for a plurality of radios such as radio 104.

The gateways 100 and 101 are linked by a communication link to a media server 105.

When a deployment requires more radios than the radio interfaces provided by one of the gateways 100 and 101 the other gateway is required to increase the number of radio interface ports. The media server 105 patches communications between radios associated with the ports of the gateway 100 and radios associated with the gateway 101.

Therefore radios 102 and 103 can be patched by the gateway 100 if communication between one of the radios associated with gateway 100 and a radio associated with gateway 101 is required. The gateway 100 for example will route the received audio to media server 105 and the server 105 will route the audio to gateway 101 for retransmission to radio 104.

The received audio from radio 102 will experience transcode delay in gateway 100 and network transmission delay from gateway 100 to the server 105. Transcode and transmission delay are grouped as one-hop 107 delay at less than 100 ms. Likewise retransmitted audio 106 from media server 105 to gateway 101 will constitute another transcode and transmission delay. Hence, audio from radio one 102 to radio three 104 across the different radio gateways will experience a total of two-hops delay less than 200 ms.

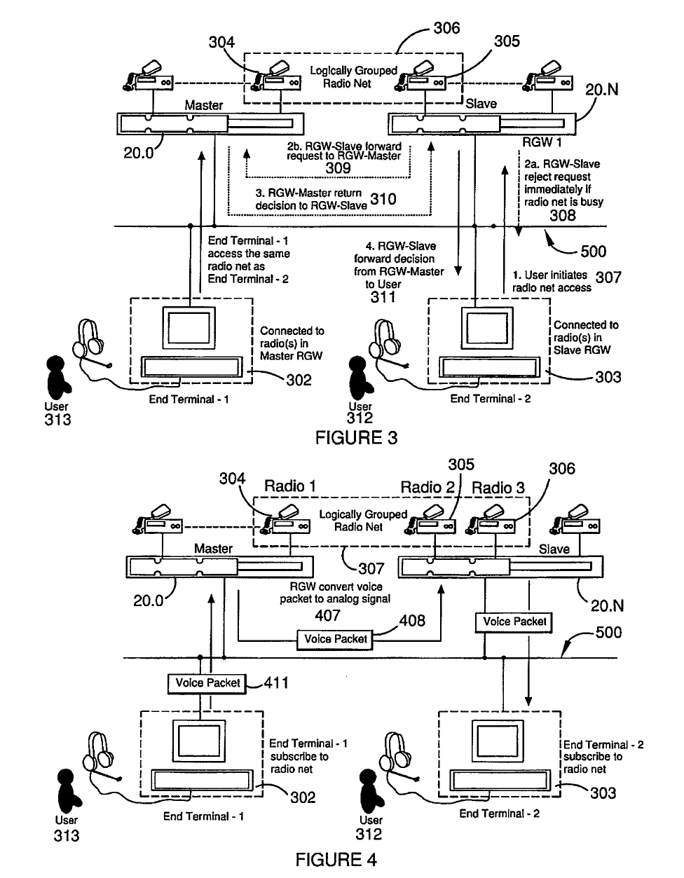

FIG. 2 shows a network configuration according to one embodiment of the present invention.

The network configuration has a number of gateways 20.0, 20.1 . . . . 20.N.

The gateways are connected on a communication link such as the Ethernet 500 and the network may include additional gateways 200.0 and 200.N.

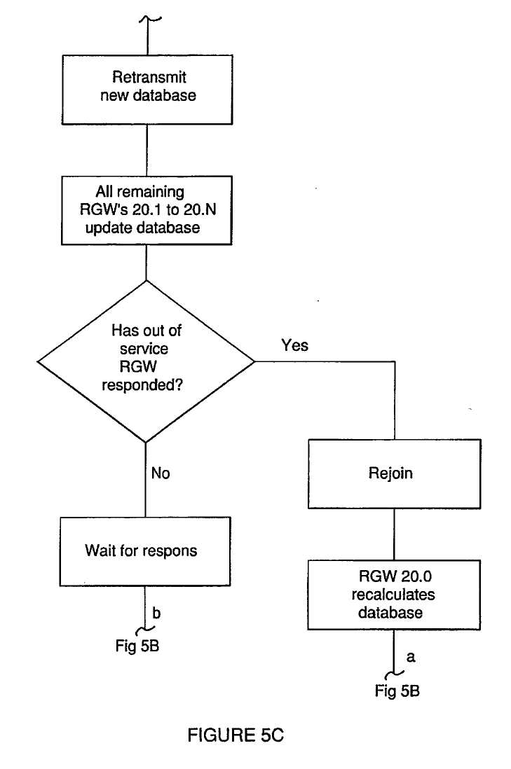

With further reference to FIG. 2 and the flowchart of FIGS. 5a to 5c, one of the gateways 20.0 to 20.N is configured as a master gateway and provided with a unique identification number such as the number 1. The remaining gateways 20.1 to 20.N will act as slave gateways and will be configured to other identification numbers greater than 1.

The gateways 20.0 to 20.N therefore will form a cascading gateway configuration.

The configuration of the gateways 20.0 to 20.N can be done via a front panel LCD screen menu structure of the gateways or via a device built in web server or external configuration download from an external server. After the gateways have been so configured and powered, the gateway 20.0 which forms the master gateway will poll the gateways 20.1 to 20.N. At the same time the gateways 200.0 to 200.N are able to function as a stand alone unit accepting radio access request to individual radio interface ports associated with each of those respective gateways.

The gateway 20.0 commences a discovery process by broadcasting message 20 to the network requesting all other gateways 20.1 to 20.N in the network to reply. Gateways 200.0 to 200.N that are not configured with the unique identification to participate in the cascading system will ignore the command and continue the function in stand alone mode and may coexist with the cascading system in the same network.

The gateways 20.1 to 20.N will respond with signals 22 to 2N to gateway 20.0 upon receiving the broadcast message 20 from the gateway 20.0.

Each gateway 20.1 to 20.N sends 8 dialing number associated to each of their radio interface ports to the gateway 20.0. The configured system will ensure that a unique dialing number is allocated to each radio interface port and that dialing numbers are unique amongst the radio interface ports across different gateways.

The gateway 20.0 will collect the dialing numbers for the radio interface ports from all of the gateways 20.1 to 20.N and compute the available number of radio net. A radio net is a group of radios being grouped logically as a single net. When a user initiates a press to talk function to a radio net all the radios within the net will be activated simultaneously. The radio net can only be formed with at least two radios. When the radio net is established a unique number is assigned to the radio net so that all users that wish to access the radio net need only dial the unique number.

The number of available radio net is calculated using the following equation:

Number of available radio net=total number of radio interface ports in the cascading system divided by 2. (1)

The above equation providing half the token number of radio interface ports represents the maximum number of logical net which can be set up. This therefore serves as the upper boundary of the system. The lower boundary of the system is one logical net. The user can set up any number of radios in the net between the lower and upper bounds.

The gateway 20.0 will assign a unique dialing number automatically to each of the available radio net as computed using the above equation. The dialing number for each of the radio interface ports and radio net in the cascading system will be stored logically in a database of the gateway 20.0 as a directory. In addition, the gateway 20.0 will broadcast the database to all the slave gateways 20.1 to 20.N in the cascading system.

The gateways 20.1 to 20.N will store the dialing directory as prepared by gateway 20.0 into their own local database. Hence all of the gateways will have a common database of the resources available in the cascading system. The gateway 20.0 will then end the discovery process.

The system of the preferred embodiment of the invention may have more than one radio net. Each radio net is usually exclusive so that a particular radio cannot be a member of two or more nets but can only be a member of one radio net.

Furthermore, the radio net may be a permanent radio net after initial establishment which means that the radio net will be established every time the system is started.

However, the radio net could be an ad hoc radio net which means that it will not be saved when the system is shut down and needs to be reestablished each time the system starts up.

After the discovery process has been completed the master database 20.0 progresses into a equipment keep alive process in which the gateway 20.0 broadcasts a heartbeat message to all participating gateways 20.1 to 20.N at a constant interval. The gateways 20.1 to 20.N respond to the gateway 20.0 as an indication of the readiness of the equipment. In the event of any of the gateways 20.1 to 20.N failing to respond, the gateway 20.0 will take note of the gateway identification that has failed to respond. The gateway 20.0 repeats the heartbeat message and if after, say, a couple of repeats the gateway or the gateways 20.1 to 20.N still does not respond the gateway will declare identified gateway out of service and remove its dialing numbers of the radio interface port from the database. The gateway 20.0 will recomputed the number of available radio net using the above equation and update the database 200. The database will be broadcast by the master gateway 20.0 to all remaining gateways in the cascading system and the database will be stored by the remaining gateways.

Hence the gateways will always have the latest information on the total number of radio interface ports and radio net available in the cascading system.

When the other service gateway resumes its response to the gateway 20.0 heartbeat message, the gateway 20.0 will include the available radio interface port of the resumed gateways and recompute the available radio net using the above equation and update its database again. The updated database will transmitted to all of the remaining gateways including the resumed to service gateway in the cascading system.

The network is now ready to receive user initiated voice messages for transmission to radios in the radio net as well as the radios outside the radio net.

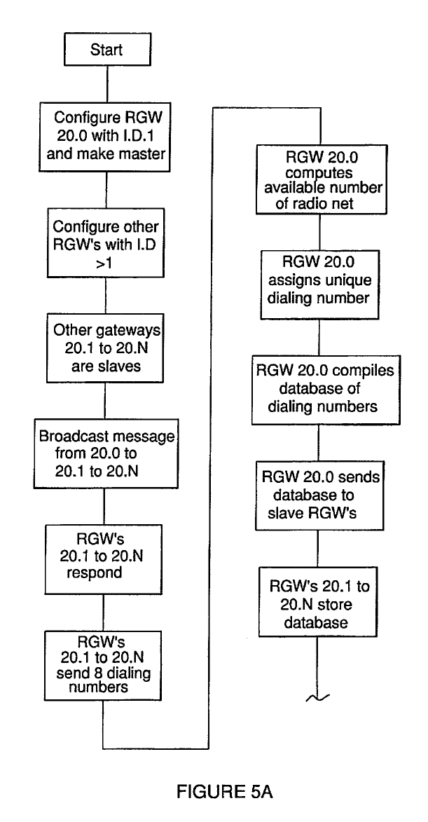

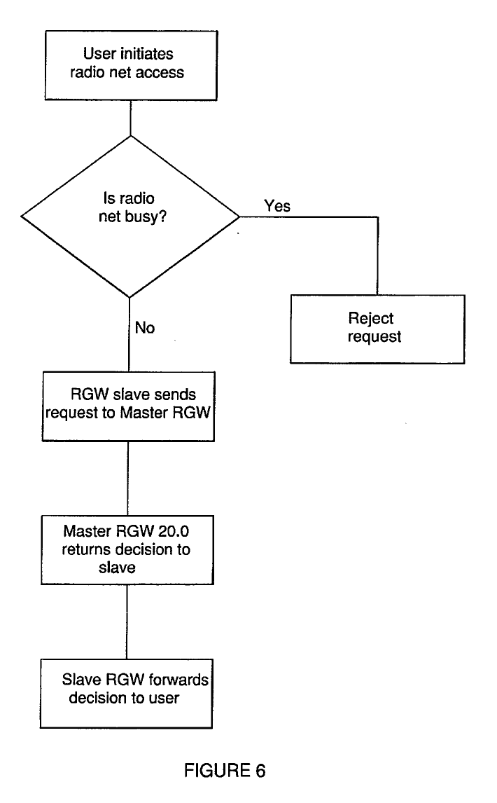

With reference to FIG. 3 and the flowchart of FIG. 6, the end user terminals 302 and 303 may access the radio net.

In the example of FIG. 3, the end user terminal 303 is connected to radios in the group of slave gateways 20.1 to 20.N. If the end user terminal initiates a radio net access by a user 312 at the end terminal pressing the PTT switch to initiate voice transmission from the console 303 to the radio net 306, at PTT request message 307 from the console address to the dial in number of the radio 305 will be sent to the gateway 20.N.

The gateway 20.N will forward the PTT request message to the master gateway 20.0. A PTT request to any other of the gateways must always be forwarded to the master gateway 20.0 in the cascading system. The gateway 20.0 will decide whether to grant the access based on either first come first served or higher priority first policy. The gateway 20.0 will send a message 310 to the requesting gateway 20.N that the request is granted. The gateway 20.N will then forward the message 311 to the console 303. Upon receiving the PTT access grant message 311, the console 303 will stream packetized voice from user 312 to the gateway 20.N. The console 303 will reach both radios 304 and 305 since they are logically grouped into a radio net.

If the terminal 303 sends a message to the gateway 20.N and the radio net is busy, the gateway 20.N can return a message to the end terminal 303 advising that the request has been rejected.

The end console 302 may function in the same manner to transmit voice messages to the individual radios associated with gateway 20.0 or to the radios in the radio net when activated by user 313. In this instance the request message is provided direct to the master gateway 20.0 which then makes the required decision to grant or reject the request.

The master gateway 20.0 has the system overall PTT access information. Besides informing the requesting gateway 20.N, gateway 20.0 will also inform the rest of the gateways in the cascading system. Hence this coordinated control scheme via gateway 20.0 will coordinate the radio access for the entire cascading system, and prevent multiple access to the same radio interface called at the same time.

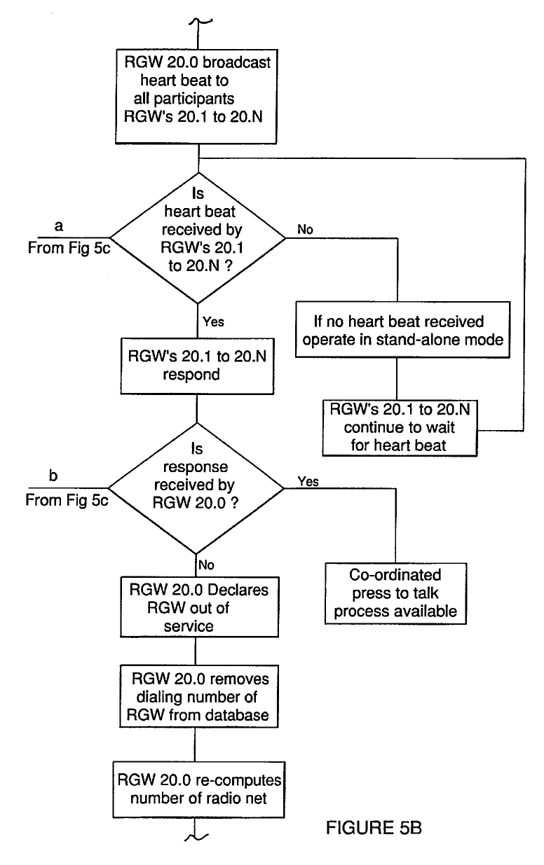

FIG. 4 is a diagram similar to FIG. 3 which shows the data flow path for voice data from one of the users to the radio net 307.

Packetized voice transmission is distributed and will not be centrally controlled by master gateway 20.0. Console 302 will send packetized voice 411 to gateway 20.0. Since the radio access is to radio net 307 the gateway 20.0 will decode the packetized voice into analog audio for transmission to radio 1 being radio 304 in the radio net. The conversion of packetized voice into analogue audio signal 407 will incur a latency of around 100 ms to 150 ms.

At the same time gateway 20.0 will forward the voice 408 to gateway 20.N. Since the forwarded packet 408 did not convert to analogue form, it nearly incurs a minimal network delay of less than 10 ms.

Radios 2 and 3 being radios 305 and 306 in FIG. 4 are members of the radio net 307. Packetized voice 408 forwarded by the gateway 20.0 that arrive at gateway 20.N will be converted to analogue audio 413 for transmission to radios two and three. The analogue audio arriving at radios 2 and 3 will then incur a voice conversion 413 and network delay 408.

Master gateway 20.0 will not only forward packetized voice 408 to gateway 20.N. If there are other gateways that have radios participating in the same radio net 307 gateway 20.0 will also forward the packetized voice to the respective gateway at the same time.

Gateway 20.N upon receiving the packetized voice 408 will not only convert to analogue audio for radio transmission to radios 2 and 3, it will also forward to any end terminals that may have connected to the radio net 307. Gateway 20.N also forwards the packetized voice to end terminal 303.

End terminal 303 converts the packetized voice into analogue audio for play out to its user 312. Hence, the analogue audio will reach its user 312 at a delay of 100 ms to 150 ms conversion delay plus two minimal network delays of less than 20 ms.

The distributed voice transmission algorithm in gateway 20.0 will ensure voice transmission from user 303 to reach radios 1, 2, 3 etc and user 312 at almost the same instance of time. Hence the minimum and maximum voice latency within the cascading system is given by equations 2 and 3 as follows:

Minimum voice latency=packetized voice conversion to analogue audio delay at the first receiving gateway. (2)

Maximum voice latency=twice the network transmission delay+the packetized voice conversion to analogue audio delay at the final receiving end terminal. (3)

It will be understood to persons skilled in the art of the invention that many modifications may be made without departing from the spirit and scope of the invention.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. A radio gateway network for radio voice communications using voice-over-internet protocol, the network comprising:
a first radio gateway having at least one radio interface port;
at least one second radio gateway having at least one radio interface port;
the first radio gateway being configured to act as a master gateway and for polling the at least one second gateway for determining the available radio interface ports to establish at least one radio net comprised of radios which commute with at least two of the gateways of the group comprising the first gateway and at least one second gateway;
a communication link between the first gateway and the at least one second gateway; and
wherein the first gateway receives a request for connection to the radios associated with the radio interfaces of the first gateway and at least one second gateway and grants or rejects access so that upon grant of access an end terminal transmits a voice signal to one of the gateways via the communication link for transmission to individual radios connected to the radio interface ports and/or the radios in the at least one radio net.

2. The network of claim 1, wherein the first gateway establishes a database of unique dialing numbers for each radio interface port and each radio net and is for transmitting the database to each of the at least one second gateway.

3. The network of claim 1, wherein at least two of the gateways comprise the first gateway and at least one second gateway.

4. The network of claim 1, wherein the first gateway is for transmitting a signal to the at least one second gateway and for receiving a response from the at least one second gateway to provide an indication of the readiness of the network.

5. The network of claim 1, wherein the first gateway is for removing the unique dialing number of a non-responding one of the at least one second gateway and for updating the database after removal of that dialing number and transmitting the updated database to the remaining gateways in the gateways comprising the at least one second gateway.

6. The network of claim 1, wherein the first gateway is for receiving a signal back from the at least one second gateway and in the event that no signal is received from all of the gateways comprising the at least one second gateway, the first gateway is for shutting down the radio net and reverting back to operation in a stand alone mode in which the first gateway communicates only with radios associated with its radio interfaces.

7. The network of claim 1, wherein the first gateway is for determining receipt of the signal from a gateway of the at least one second gateways following removal of the unique number of that gateway and returning that gateway to the network by redetermining the available radio net and updating the database, and transmitting the updated database to all of the gateways comprised of the at least one second gateway.

8. The network of claim 1, wherein the first gateway and at least one second gateway receives a request from the end terminal to initiate a voice-over-internet protocol to communicate with radios associated with the gateways; and
when the first gateway receives the request the first gateway either grants or rejects the request and transmits that decision back to the end terminal.

9. The network of claim 8, wherein the first gateway grants or rejects the request based on any one of a first come first serve basis, and a higher priority first policy.

10. A radio gateway method to provide for radio voice communications using voice-over-internet protocol, the method comprising:
providing a first radio gateway having at least one radio interface port;
providing at least one second radio gateway having at least one radio interface port;
configuring the first radio gateway to act as a master gateway and for polling the at least one second gateway for determining the available radio interface ports to establish at least one radio net comprised of radios which commute with at least two of the gateways of the group comprising the first gateway and at least one second gateway;
establishing a communication link between the first gateway and the at least one second gateway; and
wherein the first gateway receives a request for connection to the radios associated with the radio interfaces of the first gateway and at least one second gateway and grants or rejects access so that upon grant of access an end terminal transmits a voice signal to one of the gateways via the communication link for transmission to individual radios connected to the radio interface ports and/or the radios in the at least one radio net.

11. The method of claim 10, wherein the first gateway establishes a database of unique dialing numbers for each radio interface port and each radio net and is for transmitting the database to each of the at least one second gateway.

12. The method of claim 10, wherein the first gateway transmits a signal to the at least one second gateway and receives a response from the at least one second gateway to provide an indication of the readiness of the network.

13. The method of claim 10, wherein the first gateway removes the unique dialing number of a non-responding one of the at least one second gateway and updates the database after removal of that dialing number and transmits the updated gateway to the remaining gateways in the gateways comprising the at least one second gateway.

14. The method of claim 10, wherein the first gateway receives a signal back from the at least one second gateway and in the event that no signal is received from all of the gateways comprising the at least one second gateway, the first gateway shuts down the radio net and reverts back to operation in a stand alone mode in which the first gateway communicates only with radios associated with its radio interfaces.

15. The method of claim 10, wherein the first gateway determines receipt of the signal from a gateway of the at least one second gateways following removal of the unique number of that gateway and returns that gateway to the radio net by redetermining the available radio net and updating the database, and transmitting the updated database to all of the gateways comprised of the at least one second gateway.

16. The method of claim 10, wherein one of the first gateway and at least one second gateway receives a request from an end terminal to initiate a voice-over-internet protocol to communicate with radios associated with the gateways; and
when the first gateway receives the request the first gateway either grants or rejects the request and transmits that decision back to the end user terminal.

17. The method of claim 16, wherein in the event that a request being received by the at least one second gateway, the at least one second gateway transmits a signal back to the end terminal rejecting the request if the radio net is busy, or otherwise transmits the request to the first gateway so the first gateway can either grant or reject the request and transmit a decision back to the at least one second gateway for retransmission to the user end terminal.

18. The method of claim 17, wherein the first gateway grants or rejects the request based on any one of a first come first serve basis, and a higher priority first policy.
